(19) United States
(12) Patent Application Publication
(10) Pub. No.: US 2026/0132247 A1
(43) Pub. Date: May 14, 2026

(54) POLYESTER POLYOLS HAVING IMPROVED PERFORMANCE PROPERTIES

(71) Applicant: Eastman Chemical Company, Kingsport, TN (US)

(72) Inventor: Rui Xie, Pearland, TX (US)

(73) Assignee: Eastman Chemical Company, Kingsport, TN (US)

(21) Appl. No.: 19/119,128

(22) PCT Filed: Oct. 5, 2023
(86) PCT No.: PCT/US2023/076078

§ 371 Date: Apr. 8, 2025

Related U.S. Application Data
(60) Provisional application No. 63/415,138, filed on Oct. 11, 2022.

(51) Int. Cl. C08G 63/199; C08G 18/08; C08G 18/42; C08G 63/78

(52) U.S. Cl. CPC C08G 63/199; C08G 18/08; C08G 18/4238; C08G 63/78

(57) ABSTRACT

A polyester polyol comprising structural units derived from: (a) a polybasic acid; and (b) a polyhydric alcohol mixture comprising: (i) a diol having a linear or branched hydrocarbon chain between two hydroxyl groups, wherein the hydrocarbon chain has an odd number of carbon atoms of from 3 to 19; (ii) a poly hydric alcohol having a cyclic structure; and (iii) 2,2,4,4-tetraalkyl-1,3-cyclobutanediol (TACD).

### TECHNICAL FIELD

Embodiments of the present disclosure generally relate to polyester polyols, and more particularly, relate to polyester polyols having improved performance properties.

### BACKGROUND

Polyester polyols are widely used in the preparation of polyurethanes for coating, adhesive, sealant, and elastomer applications due to their outstanding mechanical strength and chemical resistance. However, many conventional polyester polyols are solid or are a highly viscous liquid at room temperature, making them unsuitable for room temperature applications, such as electronic potting and conformal coating applications. Furthermore, the high viscosity can restrict the amount of fillers or additives that can be incorporated in the formulations.

To overcome the challenge, polyester polyols have been used with other polyols that have lower viscosity at room temperature, such as polyether polyols and polybutadiene polyols. However, polyester polyols, for e.g., those with molecular weight greater than 800 daltons, have very limited compatibility with polyether polyols or polybutadiene polyols. Compatibility is even further limited when the polyether or polybutadiene polyols have a molecular weight of greater than 1,000 daltons. Poor compatibility may affect the stability of a formulation as well as its appearance (such as, clarity). This may be of particular importance in coating and adhesives.

Further, in some applications, such as coating, adhesive, elastomer, sealant, or foam applications, the coating, adhesive, elastomer, sealant, or foam may be exposed to moisture at an elevated temperature. For example, a coating or adhesive used in food packaging can experience elevated temperature and moisture when the packaging is subject to retort. Where polyurethanes based on conventional polyester polyols are used, the polyester polyols can often suffer from hydrolysis due to cleavage of the ester linkage in the backbone when they are exposed to moisture at elevated temperature. These shortcomings can significantly limit the use of polyester polyols in demanding polyurethane applications where heat and hydrolytic stability are a must.

To improve hydrolytic stability of polyurethanes based on conventional polyester polyols, hydrolytic stabilizers, such as those based on polymeric carbodiimide, may be incorporated into the formulations. Another method to improve hydrolytic stability is to incorporate dimer fatty acids into the synthesis of polyester polyols. While these solution enhance the overall hydrolytic stability of the polyester polyols, neither solution addresses the viscosity properties of the polyester polyols at room temperature nor improves their compatibility with polyether or polybutadiene polyols.

Accordingly, there remains a need for a polyester polyol that is a low viscosity liquid at room temperature, has improved compatibility with polyether and polybutadiene polyols, and exhibits improved hydrolytic stability and heat resistance.

### SUMMARY

Disclosed in embodiments herein are polyester polyols. The polyester polyols comprising structural units derived from: (a) a polybasic acid; and (b) a polyhydric alcohol mixture comprising: (i) a diol having a linear or branched hydrocarbon chain between two hydroxyl groups, wherein the hydrocarbon chain has an odd number of carbon atoms of from 3 to 19; (ii) a polyhydric alcohol having a cyclic structure; and (iii) 2,2,4,4-tetraalkyl-1,3-cyclobutanediol (TACD).

Further disclosed in embodiments herein are methods for manufacturing polyester polyols. The method comprises reacting (a) a polybasic acid; and (b) a polyhydric alcohol mixture comprising: (i) a diol having a linear or branched hydrocarbon chain between two hydroxyl groups, wherein the hydrocarbon chain has an odd number of carbon atoms of from 3 to 19; (ii) a polyhydric alcohol having a cyclic structure; and (iii) 2,2,4,4-tetraalkyl-1,3-cyclobutanediol (TACD), to form a polyester polyol.

Further disclosed in embodiments herein are methods for producing a polyurethane. The methods comprise reacting a polyisocyanate with a polyester polyol comprising structural units derived from: (a) a polybasic acid; and (b) a polyhydric alcohol mixture comprising: (i) a diol having a linear or branched hydrocarbon chain between two hydroxyl groups, wherein the hydrocarbon chain has an odd number of carbon atoms of from 3 to 19; (ii) a polyhydric alcohol having a cyclic structure; and (iii) 2,2,4,4-tetraalkyl-1,3-cyclobutanediol (TACD).

Further disclosed in embodiments herein are polyurethanes. The polyurethane comprises a reaction product of a polyisocyanate and a polyester polyol comprising structural units derived from: (a) a polybasic acid; and (b) a polyhydric alcohol mixture comprising: (i) a diol having a linear or branched hydrocarbon chain between two hydroxyl groups, wherein the hydrocarbon chain has an odd number of carbon atoms of from 3 to 19; (ii) a polyhydric alcohol having a cyclic structure; and (iii) 2,2,4,4-tetraalkyl-1,3-cyclobutanediol (TACD).

In one or more embodiments herein, the polyhydric alcohol mixture comprises from 20 mol. % to 80 mol. % of component (i), from 15 mol. % to 35 mol. % of component (ii), and from 5 mol. % to 20 mol. % of component (iii), wherein the mol. % is based on the total polyhydric alcohol mixture.

In one or more embodiments herein, the component (i) comprises 3-methyl-1,5-pentanediol, 1,5-pentanediol, 1,3 propanediol or combinations thereof.

In one or more embodiments herein, the component (ii) comprises 1,4-cyclohexanedimethanol, 4,4′-Isopropylidenedicyclohexanol, 1,3-cyclopentanediol, 1,4-cyclohexanediol, 1,4-benzenedimethanol, 4,8-bis(hydroxymethyl)tricyclo[5.2.1.0 2,6]decane, or combinations thereof.

In one or more embodiments herein, the polyhydric alcohol mixture further comprises (iv) an acyclic diol or polyol that is different from component (i), component (ii), and component (iii).

In one or more embodiments herein, the polyhydric alcohol mixture is substantially free of fused heterocyclic, bicyclic polyhydric alcohols.

In one or more embodiments herein, the polybasic acid is selected from the group consisting of adipic acid, sebacic acid, dodecanedioic acid, azelaic acid, succinic acid, glutaric acid, pimelic acid, suberic acid, isophthalic acid, terephthalic acid, cyclohexanedicarboxylic acid, naphthalenedicarboxylic acid, phthalic anhydride, hexahydrophthalic anhydride, and combinations thereof.

In one or more embodiments herein, the mole ratio of the polyhydric alcohol mixture to the polybasic acid is from 1.4:1 to 1.01:1.

Additional features and advantages of the embodiments will be set forth in the detailed description which follows, and in part will be readily apparent to those skilled in the art from that description or recognized by practicing the embodiments described herein. It is to be understood that both the foregoing and the following description describe various embodiments and are intended to provide an overview or framework for understanding the nature and character of the claimed subject matter.

### DETAILED DESCRIPTION

Reference will now be made in detail to embodiments of polyester polyols, methods of manufacturing thereof, methods of producing polyurethanes, and polyurethanes. The polyester polyols may be used in the manufacture of polyurethanes. The polyurethanes may be used in coating, adhesive, elastomer, sealant, or foam applications. It is noted, however, that this is merely an illustrative implementation of the embodiments disclosed herein. The embodiments are applicable to other technologies that are susceptible to similar problems as those discussed above.

In embodiments herein, the polyester polyol comprises structural units derived from a polybasic acid and a polyhydric alcohol mixture. As used herein, the term “polyhydric alcohol” refers to an alcohol that has at least two hydroxyl (OH) groups. In some embodiments herein, the mole ratio of the polyhydric alcohol mixture to the polybasic acid is from 1.4:1 to 1.01:1. All individual values and subranges are included and disclosed herein. For example, in some embodiments, the mole ratio of the polyhydric alcohol mixture to the polybasic acid is from 1.3:1 to 1.01:1, 1.25:1 to 1.05:1, 1.25:1 to 1.10:1, or 1.25:1 to 1.15:1.

In embodiments herein, the polybasic acid may be a dicarboxylic acid, a dicarboxylic acid derivative, or combinations thereof. The polybasic acids described herein may or may not be substituted. In some embodiments, the polybasic acid may be an aliphatic or aromatic dicarboxylic acid, an aliphatic or aromatic dicarboxylic acid derivative, or combinations thereof. In some embodiments, the polybasic acid is selected from the group consisting of adipic acid, sebacic acid, dodecanedioic acid, azelaic acid, succinic acid, glutaric acid, pimelic acid, suberic acid, isophthalic acid, terephthalic acid, cyclohexanedicarboxylic acid, naphthalenedicarboxylic acid, phthalic anhydride, hexahydrophthalic anhydride, and combinations thereof.

In embodiments herein, the polyhydric alcohol mixture comprises: (i) a diol having a linear or branched hydrocarbon chain between two hydroxyl groups, wherein the hydrocarbon chain has an odd number of carbon atoms of from 3 to 19; (ii) a polyhydric alcohol having a cyclic structure; and (iii) 2,2,4,4-tetraalkyl-1,3-cyclobutanediol (TACD). In some embodiments herein, the polyhydric alcohol mixture comprises from 20 mol. % to 80 mol. % of component (i), from 15 mol. % to 35 mol. % of component (ii), and from 5 mol. % to 20 mol. % of component (iii), wherein the mol. % is based on the total polyhydric alcohol mixture. All individual values and subranges are included and disclosed herein. For example, in some embodiments, the polyhydric alcohol mixture comprises from 20, 30, 40, or 50 mol. % to 80, 75, or 70 mol. % of component (i), from 15 or 20 mol. % to 35, 30, or 25 mol. % of component (ii), and from 5 or 10 mol. % to 20, 15, or 10 mol. % of component (iii), wherein the mol. % is based on the total polyhydric alcohol mixture.

In one or more embodiments herein, examples of suitable component (i) alcohols, may include but are not limited to, C3-C19 aliphatic or aromatic diols, substituted C3-C19 aliphatic or aromatic diols, C7-C19 aliphatic or aromatic triols, of course, wherein the hydrocarbon chain has an odd number of carbon atoms excluding carbon atoms in the side chain. In some embodiments, component (i) is selected from the group consisting of 1,3-propanediol, substituted 1,3-propanediol, 1,5-pentanediol, substituted 1,5-pentanediol (such as, 3-methyl-1,5-pentanediol), heptanediols, substituted heptanediols, nonanediols, substituted nonanediols, undecanediols, substituted undecanediols, tridecanediols, substituted tridecanediols, pentadecanediols, substituted 1,15-pentadecanediols, heptadecanediols, substituted heptadecanediols, nonadecanediols, substituted nonadecanediols. In some embodiments herein, component (i) comprises 3-methyl-1,5-pentanediol, 1,5-pentanediol, 1,3 propanediol or combinations thereof.

In one or more embodiments herein, examples of suitable component (ii) alcohols, may include but are not limited to, 1,4-cyclohexanedimethanol, 1,3-cyclohexanedimethanol, cis-1,2-cyclohexanedimethanol, 1,4-cyclohexanediol, 1,3-cyclohexanediol, 1,2-cyclohexanediol, 1,3-cyclohexanediol 4-methyl-1,2cyclohexanedimethanol, 4-cyclopentene-1,3-diol, 4,4′-Isopropylidenedicyclohexanol, 1,4-benzenedimethanol, hydroquinone bis(2-hydroxyethyl) ether, 1,2-benzenedimethanol, 1,4-bis(2-hydroxyethyl)benzene, resorcinol bis(2-hydroxyethyl) ether, bis(2-hydroxyethyl) terephthalate, 2,2′-(o-phenylenedioxy) diethanol, and the like. In some embodiments herein, component (ii) comprises 1,4-cyclohexanedimethanol, 4,4′-Isopropylidenedicyclohexanol, 1,4-cyclohexanediol, 1,4-benzenedimethanol, 1,3-cyclopentanediol, 4,8-bis(hydroxymethyl)tricyclo[5.2.1.0^{2.6}]decane, or combinations thereof.

Examples of TACDs include 2,2,4,4-tetramethylcyclobutane-1,3-diol (TMCD), 2,2,4,4-tetraethylcyclobutane-1,3-diol, 2,2,4,4-tetra-n-propylcyclobutane-1,3-diol, 2,2,4,4-tetra-n-butylcyclobutane-1,3-diol, 2,2,4,4-tetra-n-pentylcyclobutane-1,3-diol, 2,2,4,4-tetra-n-hexylcyclobutane-1,3-diol, 2,2,4,4-tetra-n-heptylcyclobutane-1,3-diol, 2,2,4,4-tetra-n-octylcyclobutane-1,3-diol, 2,2-dimethyl-4,4-diethylcyclobutane-1,3-diol, 2-ethyl-2,4,4-trimethylcyclobutane-1,3-diol, 2,4-dimethyl-2,4-diethyl-cyclobutane-1,3-diol, 2,4-dimethyl-2,4-di-n-propylcyclobutane-1,3-diol, 2,4-n-dibutyl-2,4-diethylcyclobutane-1,3-diol, 2,4-dimethyl-2,4-diisobutylcyclobutane-1,3-diol, and 2,4-diethyl-2,4-diisoamylcyclobutane-1,3-diol. In one or more embodiments herein, TACD may comprise or be TMCD.

In embodiments herein, the polyhydric alcohol mixture may further comprise (iv) an acyclic diol or polyol that is different from component (i), component (ii), and component (iii). Examples of suitable acyclic diols or polyols may include, but are not limited to, 1,2-propanediol, 1,3-butanediol, 1,4-butanediol, 1,6-hexanediol, 2,2,4,4-tetramethyl-1,6-hexanediol, ethylene glycol, diethylene glycol, dipropylene glycol, tripropylene glycol, triethylene glycol, tetraethylene glycol, polyethylene glycol, neopentyl glycol, dimethyl butanediol, trimethylolpropane, 1,8-octanediol, 1,10-decanediol, and the like.

In embodiments herein, the polyhydric alcohol mixture may be substantially free of heterocyclic, fused bicyclic polyhydric alcohols. As used herein, “fused” bicyclic polyhydric alcohols refer to alcohols that have two ring structures wherein the two rings share two carbons and a bond. Examples of fused heterocyclic, bicyclic polyhydric alcohols may include, but are not limited to, isosorbide, bis(2-hydroxyethyl) isosorbide, benzofuran diols (e.g., 1-benzofuran-5,6-diol), substituted benzofuran diols, quinioline diols, substituted quinolone diols, and the like.

Also disclosed in embodiments described herein are methods of manufacturing polyester polyols. The method comprises reacting (a) a polybasic acid; and (b) a polyhydric alcohol mixture comprising: (i) a diol having a linear or branched hydrocarbon chain between two hydroxyl groups, wherein the hydrocarbon chain has an odd number of carbon atoms of from 3 to 19; (ii) a polyhydric alcohol having a cyclic structure; and (iii) 2,2,4,4-tetraalkyl-1,3-cyclobutanediol (TACD). The polybasic acid and polyhydric alcohol mixture are previously described herein, and are incorporated by reference.

Also disclosed in embodiments described herein are methods of producing a polyurethane. The methods comprise reacting a polyester polyol as described herein with a polyisocyanate. A polyurethane is obtained by this method. As used herein, a “polyisocyanate” is any compound that contains two or more isocyanate groups. In some embodiments, the polyisocyanate may be an aliphatic isocyanate or a cycloaliphatic isocyanate. Examples of suitable aliphatic polyisocyanates may include aliphatic polyisocyanates that have 3 to 16 carbon atoms, or alternatively, 4 to 12 carbon atoms, in the linear or branched alkylene residue. Examples of suitable cycloaliphatic polyisocyanates may include cycloaliphatic polyisocyanates that have 4 to 18 carbon atoms, or alternatively, 6 to 15 carbon atoms, in the cycloalkylene residue. Further examples of suitable aliphatic and cycloaliphatic polyisocyanates include, but are not limited to, cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, such as 4-isocyanatomethyl-1,8-octane diisocyanate (TIN), decane di- and triisocyanate, undecane di- and triisocyanate and dodecane di- and triisocyanate, isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), xylylene diisocyanate (XDI), tetramethylxylylene diisocyanate, and dimers, trimers, and mixtures thereof. In some embodiments, the polyisocyanate selected from the group consisting of polymeric methylene diphenyl diisocyanate, hexamethylene diisocyanate biurets, hexamethylene diisocyanate isocyanurates, hexamethylene diisocyanate uretdiones, hexamethylene diisocyanate iminooxadiazinediones, hexamethylene diisocyanate allophanates, and mixtures thereof. The polyurethane may be used in coating formulations, elastomer formulations, adhesive formulations, sealant formulations, or foamable compositions.

### Test Methods

### Viscosity

Viscosity of the materials is measured by a Brookfield viscometer at 30° using spindle #27. The viscosity is reported in centipoise (cps).

### Tensile Strength

Tensile strength is measured according to ASTM D412 on an MTS Criterion Model 46 using a 100 Newton load cell. The tensile strength is reported in megapascals (MPa).

### Hydroxyl (OH) Number

Hydroxyl number is measured according to ASTM E 1899. The hydroxyl number is reported in mg KOH/g.

### Acid Number

Acid number is measured according to ASTM D664. The acid number is reported in mg KOH/g.

Compatibility with Polyether & Polybutadiene Polyols

Compatibility of the polyester polyols examples with polyether and polybutadiene polyols is further described below.

### EXAMPLES

The following specific examples are given to illustrate the process and performance properties associated with polyester polyols. The inventive and comparative examples are provided below with the details of the formulations and results are provided in Tables 1-3.

TABLE 1
Raw Materials

| | |
|---|---|
| Material/Name | Description |

Polybasic Acids

| | |
|---|---|
| Adipic Acid | Available from Sigma-Aldrich (St. Louis, MO). |
| Sebacic Acid | Available from Sigma-Aldrich (St. Louis, MO). |
| Dodecanedioic Acid | Available from Wego Chemical Group (Great Neck, NY) |

Polyhydric Alcohols

| | |
|---|---|
| 1,5-pentanediol | Available from Sigma-Aldrich (St. Louis, MO). |
| 3-methyl-1,5-pentanediol | Available from Sigma-Aldrich (St. Louis, MO). |
| 1,10-decanediol | Available from Sigma-Aldrich (St. Louis, MO). |
| 1,6-hexanediol | Available from Sigma-Aldrich (St. Louis, MO). |
| 1,4-cyclohexanedimethanol | Available from Eastman Chemical Co. (Kingsport, TN). |
| 2,2,4,4-tetramethyl- | Available from Eastman Chemical Co. (Kingsport, TN). |
| 1,3-cyclobutanediol | |

Polybutadiene Polyol

| | |
|---|---|
| KRASOL ™ LBH 2000 | polybutadiene polyol with a Mw of 2,000 g/mol, available from Cray |
| | Valley (Exton, PA). |

Polyether Polyol

| | |
|---|---|
| VORANOL ™ 220-56 | polyether polyol with a Mw of 2,000 g/mol, available |
| | from The Dow Chemical Company (Midland, MI). |

Polyisocyanate

| | |
|---|---|
| PAPI ™ 27 | polymethylene polyphenylisocyanate that contains MDI available |
| | from The Dow Chemical Company (Midland, MI). |

Antioxidants

| | |
|---|---|
| IRGAFOS ™ 168 | tris(2,4-di-tert.-butylphenyl) phosphite available from BASF SE |
| | (Ludwigshafen, Germany). |
| WESTON ™ 618F | phosphite antioxidant available from SI Group (The Woodlands, TX) |

### Inventive Example 1

In a four-neck 5-liter glass reactor equipped with a mechanical stirrer, a thermocouple, a heated partial condenser (100° C.), a Dean-Stark trap, a chilled condenser (15° C.), and a nitrogen inlet, 2072.70 grams of dodecanedioic acid, 893.37 grams of 3-methyl-1,5-pentanediol, 311.47 grams of 1,4-cyclohexanedimethanol, 155.74 grams of 2,2,4,4-tetramethyl-1,3-cyclobutanediol, 3.43 grams of IRGAFOS™ 168, and 3.43 grams of WESTON™ 618F are charged. The reactor is placed in a heating mantle connected to a temperature controller. With nitrogen on, the mixture in the reactor is slowly heated up to 110° C. Once the mixture is melted, agitation is applied at 200 rpm. With agitation on under nitrogen sweep, the mixture is heated to 230° C. at a ramp speed of 0.2° C./minute. The mixture is allowed to react further under a nitrogen blanket at 230° C. A sample is taken after 6 hours at 230° C. for acid number analysis. If the acid number is more than 1.0 mg KOH/g, the reaction will be allowed to continue until the acid number of the reaction mixture reaches less than or equal to 1.0 mg KOH/g. The resultant material is a clear liquid at room temperature with a viscosity of 6300 cps at 30° C. Hydroxyl number and acid number of the material is found to be 54 and 0.9 mg KOH/g respectively.

### Inventive Example 2

Example 1 is repeated except that 2072.70 grams of dodecanedioic acid, 730.78 grams of 1,5-pentanediol, 155.74 grams of 2,2,4,4-tetramethyl-1,3-cyclobutanediol, 389.34 grams of 1,4-cyclohexanedimethanol, 3.35 grams of IRGAFOS™ 168, and 3.35 grams of WESTON™ 618F are charged to the reactor. After the reaction is completed, the finished product is a clear liquid at room temperature with a viscosity of 5800 cps at 30° C. Hydroxyl number and acid number of the material is found to be 57 and 0.6 mg KOH/g respectively.

### Comparative Example A

Example 1 is repeated except that 1842.40 grams of dodecanedioic acid, 1171.16 grams of 1.10-decanediol, 138.43 grams of 2,2,4,4-tetramethyl-1,3-cyclobutanediol, 276.86 grams of 1,4-cyclohexanedimethanol, 3.43 grams of IRGAFOS™ 168, and 3.43 grams of WESTON™ 618F are charged to the reactor. After the reaction is completed, the finished product is a solid at room temperature. Hydroxyl number and acid number of the material is found to be 44 and 1.0 mg KOH/g respectively. As the material is a solid at room temperature, it is not suitable for room temperature processing, a key processing characteristic of this invention. No further evaluation is conducted on the composition.

### Inventive Example 3

Example 1 is repeated except that 2022.50 grams of sebacic acid, 874.44 grams of 1,5-pentanediol, 173.04 grams of 2,2,4,4-tetramethyl-1,3-cyclobutanediol, 346.08 grams of 1,4-cyclohexanedimethanol, 3.42 grams of IRGAFOS™ 168, and 3.42 grams of WESTON™ 618F are charged to the reactor. After the reaction is completed, the finished product is a clear liquid at room temperature with a viscosity of 4825 cps at 30° C. Hydroxyl number and acid number of the material is found to be 60 and 0.5 mg KOH/g respectively.

### Comparative Example B

Example 1 is repeated except that 2022.50 grams of sebacic acid, 850.90 grams of 1,6 hexanediol, 86.52 grams of 2,2,4,4-tetramethyl-1,3-cyclobutanediol, 605.64 grams of 1,4-cyclohexanedimethanol, 3.57 grams of IRGAFOS™ 168, and 3.57 grams of WESTON™ 618F are charged to the reactor. After the reaction is completed, the finished product is a solid at room temperature. Hydroxyl number and acid number of the material is found to be 65 and 1.0 mg KOH/g respectively. As the material is a solid at room temperature, it is not suitable for room temperature processing, a key processing characteristic of this invention. No further evaluation is conducted on the composition.

### Comparative Example C

Example 1 is repeated except that 910.13 grams of sebacic acid, 638.12 grams of 3-methyl-1,5-pentanediol, 1.55 grams of IRGAFOS™ 168, and 1.55 grams of WESTON™ 618F are charged to the reactor. After the reaction is completed, the finished product is a liquid at room with a viscosity of 2530 cps at 30° C. temperature. Hydroxyl number and acid number of the material is found to be 64 and 1.0 mg KOH/g respectively. The material is suitable for room temperature processing, and further evaluation on heat and hydrolytic stability is carried out.

### Inventive Example 4

Example 1 is repeated except that 1753.20 grams of adipic acid, 1040.58 grams of 1,5-pentanediol, 205.9 grams of 2,2,4,4-tetramethyl-1,3-cyclobutanediol, 411.84 grams of 1,4-cyclohexanedimethanol, 3.41 grams of IRGAFOS™ 168, and 3.41 grams of WESTON™ 618F are charged to the reactor. After the reaction is completed, the finished product is a clear liquid at room temperature with a viscosity of 5180 cps at 30° C. OH number and acid number of the material is found to be 61 and 0.8 mg KOH/g respectively.

### Comparative Example D

Example 1 is repeated except that 1753.20 grams of adipic acid, 995.55 grams of 1,6 hexanediol, 101.23 grams of 2,2,4,4-tetramethyl-1,3-cyclobutanediol, 708.60 grams of 1,4-cyclohexanedimethanol, 3.56 grams of IRGAFOS™ 168, and 3.56 grams of WESTON™ 618F are charged to the reactor. After the reaction is completed, the finished product is a solid at room temperature. Hydroxyl number and acid number of the material is found to be 65 and 1.0 mg KOH/g respectively. As the material is a solid at room temperature, it is not suitable for room temperature processing, a key processing characteristic of this invention. No further evaluation is conducted on the composition.

### Comparative Example E

Example 1 is repeated except that 774.33 grams of adipic acid, 739.04 grams of 3-methyl-1,5-pentanediol, 1.51 grams of IRGAFOS™ 168, and 1.51 grams of WESTON™ 618F are charged to the reactor. After the reaction is completed, the finished product is a liquid at room with a viscosity of 4150 cps at 30° ctemperature. Hydroxyl number and acid number of the material is found to be 54 and 0.8 mg KOH/g respectively. The material is suitable for room temperature processing, and further evaluation on heat and hydrolytic stability is carried out

### Inventive Example 5

Example 1 is repeated except that 774.33 grams of adipic acid, 147.81 grams of 3-methyl-1,5-pentanediol, 45.09 grams of 2,2,4,4-tetramethyl-1,3-cyclobutanediol, 315.64 grams of 1,4-cyclohexanedimethanol, 369.55 grams of 1,6-hexanediol, 1.58 grams of IRGAFOS™ 168, and 1.58 grams of WESTON™ 618F are charged to the reactor. After the reaction is completed, the finished product is a clear liquid at room temperature with a viscosity of 7100 cps at 30° C. Hydroxyl number and acid number of the material is found to be 62 and 1.0 mg KOH/g respectively. In contrast to Comparative Example D, incorporation of 3-methyl-1,5-pentanediol in the composition resulted in a low viscosity liquid at room temperature.

### Inventive Example 6

Example 1 is repeated except that 730.50 grams of adipic acid, 277.70 grams of 3-methyl-1,5-pentanediol, 42.36 grams of 2,2,4,4-tetramethyl-1,3-cyclobutanediol, 254.15 grams of 1,4-cyclohexanedimethanol, 255.97 grams of 1,10-decanediol, 1.58 grams of IRGAFOS™ 168, and 1.58 grams of WESTON™ 618F are charged to the reactor. After the reaction is completed, the finished product is a clear liquid at room temperature with a viscosity of 7600 cps at 30° C. Hydroxyl number and acid number of the material is found to be 65 and 1.1 mg KOH/g respectively. In contrast to Comparative Example D, incorporation of 3-methyl-1,5-pentanediol in the composition resulted in a low viscosity liquid at room temperature.

Compatibility with Polybutadiene and Polyether Polyols

To examine compatibility of the inventive examples and the comparative examples with polybutadiene polyols and polyether polyols, the inventive examples and comparative examples are mixed with KRASOL™ LBH 2000, a 2,000 Mw polybutadiene polyol and VORANOL™ 220-056N, a 2,000 Mw polyether polyol at 50:50 ratio by weight, respectively. The mixtures are thoroughly mixed by hand with a spatula. After conditioned at room temperature for 8 hours, the appearance of the mixtures is examined visually. A mixture that is transparent to the naked eye is deemed to be compatible, while a mixture that is cloudy to the naked eye is deemed to be incompatible. Tables 2 & 3 summarize the results of the compatibility study.

TABLE 2
Inventive Examples

| | Exam- | Exam- | Exam- | Exam- | Exam- | Exam- |
|---|---|---|---|---|---|---|
| | ple 1 | ple 2 | ple 3 | ple 4 | ple 5 | ple 6 |
| Dodecanedioic Acid | 2072.7 | 2187.85 | | | | |
| | (100 | (100 | | | | |
| | mol. %) | mol. %) | | | | |
| Sebacic Acid | | | 2022.5 | | | |
| | | | (100 | | | |
| | | | mol. %) | | | |
| Adipic Acid | | | | 1753.2 | 774.33 | 730.5 |
| | | | | (100 | (100 | (100 |
| | | | | mol. %) | mol. %) | mol. %) |
| 3-methyl-1,5- | 893.37 | | | | 147.81 | 277.7 |
| pentanediol | (60 | | | | (20 | (40 |
| | mol. %) | | | | mol. %) | mol. %) |
| 1,5-pentanediol | | 830.72 | 874.44 | 1040.58 | | |
| | | (70 | (70 | (70 | | |
| | | mol. %) | mol. %) | mol. %) | | |
| 1,4- | 311.47 | 410.97 | 346.08 | 411.84 | 270.55 | 254.15 |
| cyclohexanedimethanol | (30 | (25 | (20 | (20 | (30 | (30 |
| | mol. %) | mol. %) | mol. %) | mol. %) | mol. %) | mol. %) |
| 2,2,4,4-tetramethyl-1,3- | 155.74 | 82.19 | 173.04 | 205.9 | 45.09 | 42.36 |
| cyclobutanediol | (10 | (5 | (10 | (10 | (5 | (5 |
| | mol. %) | mol. %) | mol. %) | mol. %) | mol. %) | mol. %) |
| 1,6-hexanediol | | | | | 332.59 | |
| | | | | | (45 | |
| | | | | | mol. %) | |
| 1,10-decanediol | | | | | | 255.97 |
| | | | | | | (25 |
| | | | | | | mol. %) |
| IRGAFOS ™ 168 | 3.43 | 3.35 | 3.42 | 3.41 | 1.58 | 1.58 |
| WESTON ™ 618F | 3.43 | 3.35 | 3.42 | 3.41 | 1.58 | 1.58 |
| OH/COOH Ratio | 1.2 | 1.2 | 1.2 | 1.19 | 1.17 | 1.18 |
| Hydroxyl Number | 54.0 | 57.0 | 60.0 | 61.0 | 62.0 | 65.0 |
| Acid Number | 0.9 | 0.6 | 0.5 | 0.8 | 1.0 | 1.0 |
| Appearance at 30° C. | liquid | liquid | liquid | liquid | liquid | liquid |
| Viscosity at 30° C., cps | 6300 | 5800 | 4825 | 5180 | 7100 | 7600 |
| Compatibility with | Yes | Yes | No | No | No | No |
| Polybutadiene Polyol | | | | | | |
| Compatibility with | Yes | Yes | Yes | Yes | Yes | Yes |
| Polyether Polyol | | | | | | |

TABLE 3
Comparative Examples

| | Comparative | Comparative | Comparative | Comparative | Comparative |
|---|---|---|---|---|---|
| | Example A | Example B | Example C | Example D | Example E |
| Dodecanedioic Acid | 1842.4 | | | | |
| | (100 mol. %) | | | | |
| Sebacic Acid | | 2022.5 | 910.13 | | |
| | | (100 mol. %) | (100 mol. %) | | |
| Adipic Acid | | | | 1753.2 | 774.33 |
| | | | | (100 mol. %) | (100 mol. %) |
| 3-methyl-1,5- | | | 638.12 | | 739.04 |
| pentanediol | | | (100 mol. %) | | (100 mol. %) |
| 1,5-pentanediol | | | | | |
| 1,4-cyclohexane- | 276.86 | 605.64 | | 708.6 | |
| dimethanol | (20 mol. %) | (35 mol. %) | | (35 mol. %) | |
| 2,2,4,4-tetramethyl- | 138.43 | 86.52 | | 101.23 | |
| 1,3-cyclobutanediol | (10 mol. %) | (5 mol. %) | | (5 mol. %) | |
| 1,6-hexanediol | | 850.9 | | 995.55 | |
| | | (60 mol. %) | | (60 mol. %) | |
| 1,10-decanediol | 1171.16 | | | | |
| | (70 mol. %) | | | | |
| IRGAFOS ™ 168 | 3.43 | 3.57 | 1.55 | 3.56 | 1.51 |
| WESTON ™ 618F | 3.43 | 3.57 | 1.55 | 3.56 | 1.51 |
| OH/COOH Ratio | 1.2 | 1.2 | 1.2 | 1.17 | 1.18 |
| Hydroxyl Number | 44.0 | 65.0 | 64.0 | 65.0 | 54.0 |
| Acid Number | 1.0 | 1.0 | 1.0 | 1.0 | 0.8 |
| Appearance at 30° C. | Solid | Solid | liquid | Solid | liquid |
| Viscosity at 30° C., cps | NA | NA | 2530 | NA | 4150 |
| Compatibility with | No | No | No | No | No |
| Polybutadiene Polyol | | | | | |
| Compatibility with | No | No | No | No | No |
| Polyether Polyol | | | | | |

As shown in the Tables above, the formulations of the present invention exhibit low viscosity at 30° C. and improved compatibility with polybutadiene polyols or polyether polyols as compared to the comparative examples.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, if any, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A polyester polyol comprising structural units derived from:
(a) a polybasic acid; and
(b) a polyhydric alcohol mixture comprising:
(i) a diol having a linear or branched hydrocarbon chain between two hydroxyl groups, wherein the hydrocarbon chain has an odd number of carbon atoms of from 3 to 19;
(ii) a polyhydric alcohol having a cyclic structure; and
(iii) 2,2,4,4-tetraalkyl-1,3-cyclobutanediol (TACD).

2. The polyester polyol according to claim 1, wherein the polyhydric alcohol mixture comprises from 20 mol. % to 80 mol. % of component (i), from 15 mol. % to 35 mol. % of component (ii), and from 5 mol. % to 20 mol. % of component (iii), wherein the mol. % is based on the total polyhydric alcohol mixture.

3. The polyester polyol according to claim 1, wherein component (i) comprises 3-methyl-1,5-pentanediol, 1,5-pentanediol, 1,3 propanediol or combinations thereof.

4. The polyester polyol according to claim 1, wherein component (ii) comprises 1,4-cyclohexanedimethanol, 4,4′-Isopropylidenedicyclohexanol, 1,3-cyclopentanediol, 1,4-cyclohexanediol, 1,4-benzenedimethanol, 4,8-bis(hydroxymethyl)tricyclo[5.2.1.0^{2.6}]decane, or combinations thereof.

5. The polyester polyol according to claim 1, wherein the polyhydric alcohol mixture further comprises (iv) an acyclic diol or polyol that is different from component (i), component (ii), and component (iii).

6. The polyester polyol according to claim 1, wherein the polyhydric alcohol mixture is substantially free of fused heterocyclic, bicyclic polyhydric alcohols.

7. The polyester polyol according to claim 1, wherein the polybasic acid is selected from the group consisting of adipic acid, sebacic acid, dodecanedioic acid, azelaic acid, succinic acid, glutaric acid, pimelic acid, suberic acid, isophthalic acid, terephthalic acid, cyclohexanedicarboxylic acid, naphthalenedicarboxylic acid, phthalic anhydride, hexahydrophthalic anhydride, and combinations thereof.

8. The polyester polyol according to claim 1, wherein the mole ratio of the polyhydric alcohol mixture to the polybasic acid is from 1.4:1 to 1.01:1.

9. A method for manufacturing a polyester polyol, the method comprising:
(a) a polybasic acid; and
(b) a polyhydric alcohol mixture comprising:
(i) a diol having a linear or branched hydrocarbon chain between two hydroxyl groups, wherein the hydrocarbon chain has an odd number of carbon atoms of from 3 to 19;
(ii) a polyhydric alcohol having a cyclic structure; and
(iii) 2,2,4,4-tetraalkyl-1,3-cyclobutanediol (TACD), to form a polyester polyol.

10. The method of claim 9, wherein the polyhydric alcohol mixture comprises from 20 mol. % to 80 mol. % of component (i), from 15 mol. % to 35 mol. % of component (ii), and from 5 mol. % to 20 mol. % of component (iii), wherein the mol. % is based on the total polyhydric alcohol mixture.

11. The method of claim 9, wherein component (i) comprises 3-methyl-1,5-pentanediol, 1,5-pentanediol, 1,3 propanediol or combinations thereof.

12. The method of claim 9, wherein component (ii) comprises 1,4-cyclohexanedimethanol, 4,4′-Isopropylidenedicyclohexanol, 1,3-cyclopentanediol, 1,4-cyclohexanediol, 1,4-benzenedimethanol, 4,8-bis(hydroxymethyl)tricyclo[5.2.1.0^{2,6}]decane, or combinations thereof.

13. The method of claim 9, wherein the polyhydric alcohol mixture further comprises (iv) an acyclic diol or polyol that is different from component (i), component (ii), and component (iii).

14. The method of claim 9, wherein the polyhydric alcohol mixture is substantially free of fused heterocyclic, bicyclic polyhydric alcohols.

15. The method of claim 9, wherein the polybasic acid is selected from the group consisting of adipic acid, sebacic acid, dodecanedioic acid, azelaic acid, succinic acid, glutaric acid, pimelic acid, suberic acid, isophthalic acid, terephthalic acid, cyclohexanedicarboxylic acid, naphthalenedicarboxylic acid, phthalic anhydride, hexahydrophthalic anhydride, and combinations thereof.

16. The method of claim 9, wherein the mole ratio of the polyhydric alcohol mixture to the polybasic acid is from 1.4:1 to 1.01:1.

17. A method for producing a polyurethane, comprising reacting the polyester polyol according to claim 1, with a polyisocyanate.

18. The method of claim 17, wherein the polyisocyanate is selected from a group consisting of polymeric methylene diphenyl diisocyanate, hexamethylene diisocyanate biurets, hexamethylene diisocyanate isocyanurates, hexamethylene diisocyanate uretdiones, hexamethylene diisocyanate iminooxadiazinediones, hexamethylene diisocyanate allophanates, and mixtures thereof.

19. A polyurethane obtained by the method of claim 17.

20. Use of the polyurethane of claim 19 in a coating formulation, an elastomer formulation, an adhesive formulation, a sealant formulation, or a foamable composition.
